(19) United States
(12) Patent Application Publication
(10) Pub. No.: US 2005/0235447 A1
(43) Pub. Date: Oct. 27, 2005

(54) Locating structure for plaster trowel

(76) Inventor: See-Tuh Wang, Changhua County (TW)

Correspondence Address: John S. Egbert;Harrison & Egbert, 412 Main Street, 7th Floor, Houston, TX, 77002, US

(21) Appl. No.: 11/090,975

(22) Filed: Mar. 25, 2005

(30) Foreign Application Priority Data
Mar. 25, 2004 (TW) 093204567

(51) Int. Cl. B05C 17/10

(52) U.S. Cl. 15/235.4; 15/143.1

(57) ABSTRACT

The locating structure for the grip of the plaster trowel includes a low profile, a fixation frame on one side of the low profile, and a grip that connects to this fixation frame through the connecting rod. This grip has a groove hole that connects to the connecting rod of the fixation frame; the side groove that locks the groove hole of the grip and each protruding rib of the connecting rod. By this improved structure, when assembling the grip and the fixation frame, the grip may be connected to the connecting rod of the fixation frame to achieve the axial and radial locating effect, which shortens the time involved in assembling to reduce the cost by using simple components.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a plaster trowel, and more particularly to a locating structure that improves a grip and fixation frame for the plaster trowel.

### BACKGROUND OF THE INVENTION

The grip of the plaster trowel is usually located on one side of the low profile of the plaster trowel for the user to hold and operate, and they are generally connected by the fixation frame. The objective of the present invention is to improve the locating structure that connects the grip and the fixation frame, and its known structure, published in the Taiwanese National Official Gazette of Patent No 371975 (see the attachment). The main features include a through hole 33 that is built in the grip 30, and after a connecting rod 25, which is placed crosswise to the fixation frame 21 of the low profile 10, goes through the through hole 33 mentioned above, it is locked tight by a screw nut 60, and a cap 50 is placed over it to conceal the screw nut 60. The protruding rib 27 and groove 31, where one side of the through hole 33 that is built in the grip 30 and the fixation frame 21 meets, are in the locked position to prevent the grip 30 from turning. The structure still has the following issues found in practical experience.

For the users, the assembly of the structure is overloaded with details. It has to be locked in with screw nut 60 after the grip 30 is connected to the connecting rod 25 followed by a covering cap 50. Thus, in terms of both the components and assembly, it is costly and fails to meet the demand of industry.

Thus, to overcome the aforementioned problems of the prior art, it would be an advancement if the art to provide an improved locating structure for plaster trowel that can significantly improve the efficacy.

To this end, the inventor has provided the present invention of practicability after deliberate design and evaluation based on years of experience in the production, development and design of related products.

### BRIEF SUMMARY OF THE INVENTION

Technical problems to be solved: The improvement is mainly focused on the existing issues, such as overloaded procedures and the inconvenience when assembling that causes high cost, of the known locating structure of the grip of the plaster trowel.

Technical features: The main body includes a low profile, a fixation frame on one side of the low profile and the grip that connects to the connecting rod of fixation frame; the grip has a groove hole that can be connected to the connecting rod of the fixation frame. Its technical features are the connecting rod of the fixation frame having several radial protruding ribs, and the outside of each protruding rib having a monoclinal jagged edge. The side groove locks the groove hole of the grip and each protruding rib of the connecting rod mentioned above.

Comparing to the effect of the related art:

1. Providing a new structure that has several radial protruding ribs on the connecting rod of the fixation frame, and the monoclinal jagged edge on the sides of protruding rod that can be locked in with the side groove in the groove hole of the grip.

2. By this improved structure, when assembling the grip and the fixation frame, the grip may be connected to the connecting rod of the fixation frame to achieve the axial and radial locating effect, which shortens the time involved in assembling to reduce the cost by using simple components.

The effects of the present invention are as follows:

1. Providing a new structure that has a connecting rod 20 on the fixation frame that has several radial protruding ribs 21, and monoclinal jagged edge 23 on the sides of the protruding rib that can be locked in the side groove 32 of the groove hole 31 of the grip 30. It is indeed the first seen in the industry that meets the qualification for new patent.

2. By this improved structure, when assembling the grip and the fixation frame, the grip may be connected to the connecting rod of the fixation frame to achieve the axial and radial locating effect, which shortens the time involved in assembling to reduce the cost by using simple components.

The new function of the present invention is mentioned as follow:

A limit surface 24 formed on one end of the connecting rod 21 of the fixation frame 20, which makes the profile 33 over the groove hole 31 of the grip 30 pushing against it when connecting.

### BRIEF DESCRIPTION OF THE SEVERAL VIEWS OF THE DRAWINGS

FIG. 1 shows an assembled perspective view of the present invention.

FIG. 2 shows an exploded perspective view of the present invention.

FIG. 3 shows an exploded sectional view of the present invention.

FIG. 4 shows an assembled sectional view of the present invention.

FIG. 5 shows a cross-sectional view of the connection between the grip and fixation frame.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

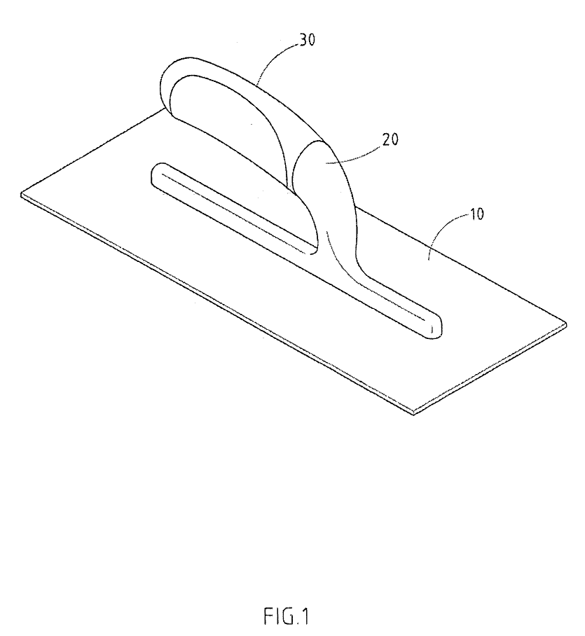

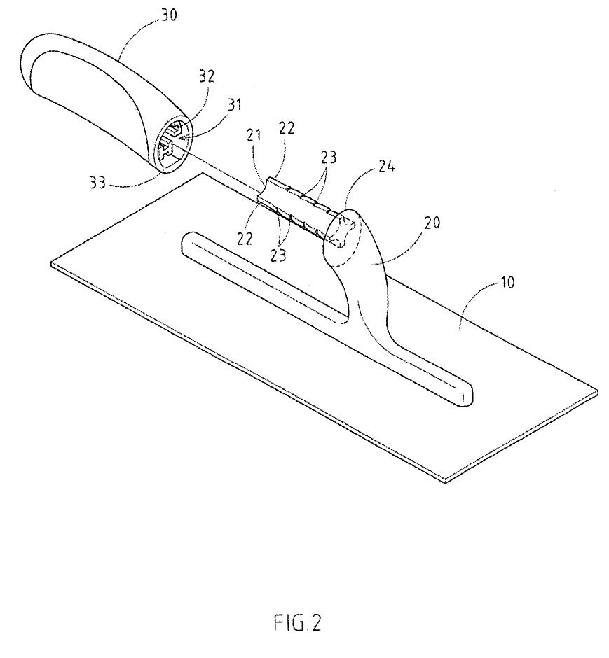

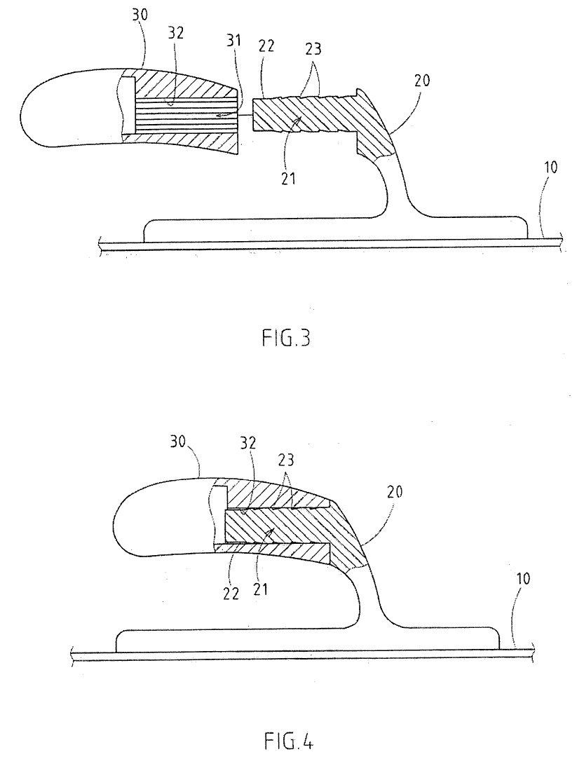

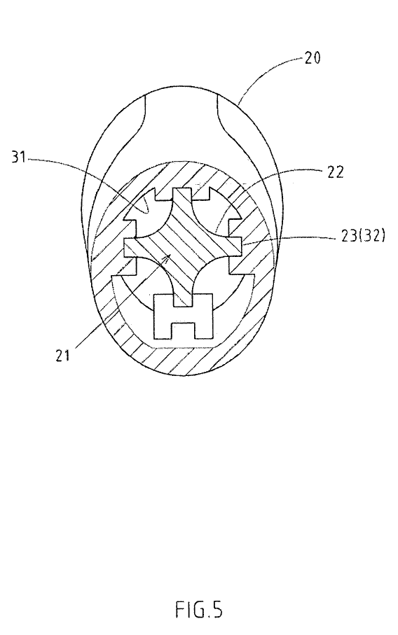

As shown in FIGS. 1-5, there is a locating structure for plastic trowel embodied in the present invention.

The invention has a low profile 10, a fixation frame 20 on the side of low profile 10, and a grip 30 that connects to the connecting rod 21 of the said fixation frame 20; and the said grip has groove hole that can be connected to the connecting rod 21 of the fixation frame 20.

The connecting rod 21 of the fixation frame 20 has several radial protruding ribs 22, and each protruding rib 22 has monoclinal jagged edge 23 on the sides; the side groove 32 that locks the groove hole 31 of the grip 30 and each protruding rib 22 of the connecting rod 21 mentioned above.

By the above mentioned structure and method of assembling, when assembling the grip 30 of the plaster trowel and fixation frame 20, simply take the grip 30 and connect it to the connecting rod 21 of the fixation frame 20, this simple process can instantly achieve the axial and radial location. The monoclinal jagged edge 23 on the sides of the protruding rib 22 on the connecting rod 21 forms an axial locating effect that is in a locked position. On the other hand, by locking the protruding rib 22 and the side groove 32, it creates radial locating effect that keeps the grip 30 from turning.

The protruding rib 22 on the connecting rod 21 of the fixation frame 20 forms a crosswise position with the side groove 32 in the groove hole 31 of the grip 30 (see FIG. 5).

A limit surface 24 formed on one end of the connecting rod 21 of the fixation frame 20, which makes the profile 33 over the groove hole 31 of the grip 30 pushing against it when connecting.

### DESCRIPTION OF THE COMPONENTS AND SIGNS

Low profile—(10)
Fixation frame—(20)
Connecting rod—(21)
Protruding rib—(22)
Jagged edge—(23)
Limit surface—(24)
Grip—(30)
Groove hole—(31)
Side groove—(32)
Profile—(33)

1-3. (canceled)

4. A locating structure for a plaster trowel grip comprising:
a low profile, a fixation frame on a side of said low profile, and a grip connected to a connecting rod of said fixation frame; the wherein said grip has groove hole connected to said connecting rod of said fixation frame;
wherein said connecting rod of said fixation frame is comprised of several radial protruding ribs, each protruding rib having a monoclinal jagged edge on sides thereof; wherein a side groove locks the groove hole of the grip and each protruding rib of the connecting rod;
wherein when assembling the grip and the fixation frame, the grip connects to the connecting rod of the fixation frame to achieve the axial and radial locating effect, shortening time involved in assembling to reduce cost by using simple components.

5. The structure defined in claim 1, wherein said protruding rib on the connecting rod of the fixation frame forms in a crosswise position with the side groove in the groove hole of the grip.

6. The structure defined in claim 1, wherein a limit surface is formed on one end of the connecting rod of the fixation frame, making a profile over the groove hole of the grip pushing against the groove hole when connecting.
